(19) United States
(12) Patent Application Publication
(10) Pub. No.: US 2015/0042589 A1
(43) Pub. Date: Feb. 12, 2015

(54) METHOD AND ELECTRONIC DEVICE FOR WIRELESS CONNECTION

(71) Applicant: Samsung Electronics Co., Ltd., Gyeonggi-do (KR)

(72) Inventors: Jung-Kuk Seo, Gyeongsangbuk-do (KR); Sang-Uk Lee, Gyeongsangbuk-do (KR); Ki-Bong Kim, Daegu (KR); Seung-Jae Lee, Daegu (KR)

(21) Appl. No.: 14/458,180

(22) Filed: Aug. 12, 2014

(30) Foreign Application Priority Data
Aug. 12, 2013 (KR) 10-2013-0095408

(51) Int. Cl. G06F 3/01

(52) U.S. Cl. CPC G06F 3/017
USPC 345/173

(57) ABSTRACT

A method in an electronic device includes receiving an input pattern, identifying a pattern identification (ID) from the input pattern, determining a counterpart electronic device corresponding to the pattern ID, and establishing a wireless connection with the corresponding electronic device. An electronic device includes a wireless communication unit configured to perform wireless communication with one or more other electronic devices, a pattern input unit configured to receive an input pattern, and a processor configured to identify a pattern from the input pattern, determine a counterpart electronic device with an ID corresponding to the pattern, and cause the wireless communication unit to wirelessly connect with the counterpart electronic device. Also, other embodiments are disclosed.

### PRIORITY

The present application is related to and claims the benefit under 35 U.S.C. §119(a) of a Korean patent application No. 102013-0095408 filed in the Korean Intellectual Property Office on Aug. 12, 2013, the entire disclosure of which is hereby incorporated by reference.

### TECHNICAL FIELD

The present disclosure relates to a method and an electronic device for wireless connection.

### BACKGROUND

Recently, as the multimedia technologies develop, electronic devices having various functions emerge. Generally, these electronic devices have a convergence feature for performing one or more functions in a complex manner.

Furthermore, a mobile terminal roughly classified as a so-called ‘smartphone’ forms a mainstream as an electronic device. Particularly, this mobile terminal has a display module of a large screen touch type, and has a mega-pixel camera module besides a basic function of communication with a counterpart user, so that it may perform still picture shooting and moving picture shooting. Also, the mobile terminal may reproduce multimedia contents such as music, moving pictures, etc., and access a network to perform web surfing. The electronic device is progressing to perform various convergence functions faster by having a high performance processor gradually, and is making remarkable development, so that the primary function of communication with a counterpart user is rather considered as an additional function.

Meanwhile, with development in a communication technology, recently, an electronic device mounting a short distance communication function such as a Bluetooth function is used. This electronic device supports services such as listening music, communication, and printing, etc. by communicating wirelessly with a headset, an earphone, a printer, etc. mounting a Bluetooth function.

For example, to perform short distance communication with neighboring other electronic devices, an electronic device having a short distance communication function retrieves an electronic device that may perform short distance communication, and performs pairing to make a communication allowed state between electronic devices, thereby performing communication.

### SUMMARY

A method in an electronic device includes receiving an input pattern, identifying a pattern identification (ID) from the input pattern, determining a counterpart electronic device corresponding to the pattern ID, and establishing a wireless connection with the corresponding electronic device.

In certain embodiments, the input pattern comprises a gesture input pattern.

In certain embodiments, the input pattern comprises a voice input pattern.

In certain embodiments, the voice input pattern is one of a plurality of pre-determined voice input patterns.

In certain embodiments, the gesture input pattern comprises at least one of flicking, a touch and drag, a tap and hold, and a multi-tab on a touchscreen of the electronic device.

In certain embodiments, the gesture input pattern comprises receiving a drawing input pattern on a touchscreen of the electronic device.

In certain embodiments, the drawing input pattern comprises a touch for a plurality of objects, and the plurality of objects have a unique data value.

In certain embodiments, identifying the pattern ID from the input pattern comprises combining with a unique data value to generate a character string.

In certain embodiments, determining a counterpart electronic device corresponding to the pattern ID comprises determining whether the counterpart electronic device has an ID matching the pattern ID.

In certain embodiments, determining a counterpart electronic device corresponding to the pattern ID comprises comparing the received input pattern of the electronic device with a input pattern of the counterpart electronic device.

In certain embodiments, when a number of the counterpart electronic devices is more than one, prioritizing the wireless connections with the counterpart electronic devices.

An electronic device includes a wireless communication unit configured to perform wireless communication with one or more other electronic devices, a pattern input unit configured to receive an input pattern, and a processor configured to identify a pattern from the input pattern, determine a counterpart electronic device with an ID corresponding to the pattern, and cause the wireless communication unit to wirelessly connect with the counterpart electronic device.

In certain embodiments, the pattern input unit is a touchscreen configured to receive a gesture input pattern.

In certain embodiments, the pattern input unit is an audio unit configured to receive a voice input pattern.

In certain embodiments, the gesture input pattern comprises at least one of flicking, a touch and drag, a tab and hold, and a multi tab on the touchscreen.

In certain embodiments, the processor is configured to receive a drawing input pattern comprising a touch for a plurality of objects having a unique data value on the touchscreen.

In certain embodiments, the processor is configured to combine the unique data value to generate a character string.

In certain embodiments, the processor is configured to determine whether the counterpart ID is the same as the character string or comprises partially same text.

In certain embodiments, the processor is configured to compare the input pattern with an input pattern of the counterpart electronic device received from the counterpart electronic device.

A method for operating an electronic device, the method includes receiving a gesture input pattern or a voice input pattern, the gesture input pattern comprising at least one of a touch on a touchscreen, a drag of the touch, and a release of the touch, and the voice input pattern comprising at least one predetermined voice pattern, identifying a pattern identification (ID) from the input pattern, the pattern ID being data comprising at least one of a number and a character, determining a counterpart electronic device having an ID corresponding to the pattern ID, the counterpart ID comprising data that is at least in part same as the data of the pattern ID, and performing wireless connection with the counterpart electronic device.

A non-transient computer readable storage medium storing one or more programs comprising instructions, when executed by an electronic device, for allowing the electronic device to perform the method including receiving an input pattern, identifying a pattern identification (ID) from the input pattern, determining a counterpart electronic device corresponding to the pattern ID and establishing a wireless connection with the corresponding electronic device.

Other aspects, advantages and salient features of the disclosure will become apparent to those skilled in the art from the following detailed description, which, taken in conjunction with the annexed drawings, discloses exemplary embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a perspective view illustrating an electronic device according to an embodiment of the present disclosure;

FIGS. 2A and 2B are views illustrating a method for receiving an input pattern of an electronic device according to an embodiment of the present disclosure;

FIG. 3 is a block diagram illustrating an electronic device according to an embodiment of the present disclosure;

FIG. 4 is a flowchart illustrating a method for operating an electronic device according to an embodiment of the present disclosure;

FIG. 5 is a flowchart illustrating a method for operating an electronic device according to another embodiment of the present disclosure;

FIG. 6 is a flowchart illustrating a method for operating an electronic device according to still another embodiment of the present disclosure;

FIG. 7 is a flowchart illustrating a method for operating an electronic device according to various embodiments of the present disclosure;

FIG. 8 is a flowchart illustrating a method for operating an electronic device according to various embodiments of the present disclosure;

FIG. 9 is a flowchart illustrating a method for operating an electronic device according to various embodiments of the present disclosure;

FIG. 10 is a flowchart illustrating a method for operating an electronic device according to various embodiments of the present disclosure; and

FIG. 11 illustrates a screen showing a connection priority ranking according to various embodiments of the present disclosure.

Throughout the drawings, like reference numerals will be understood to refer to like parts, components and structures.

### DETAILED DESCRIPTION

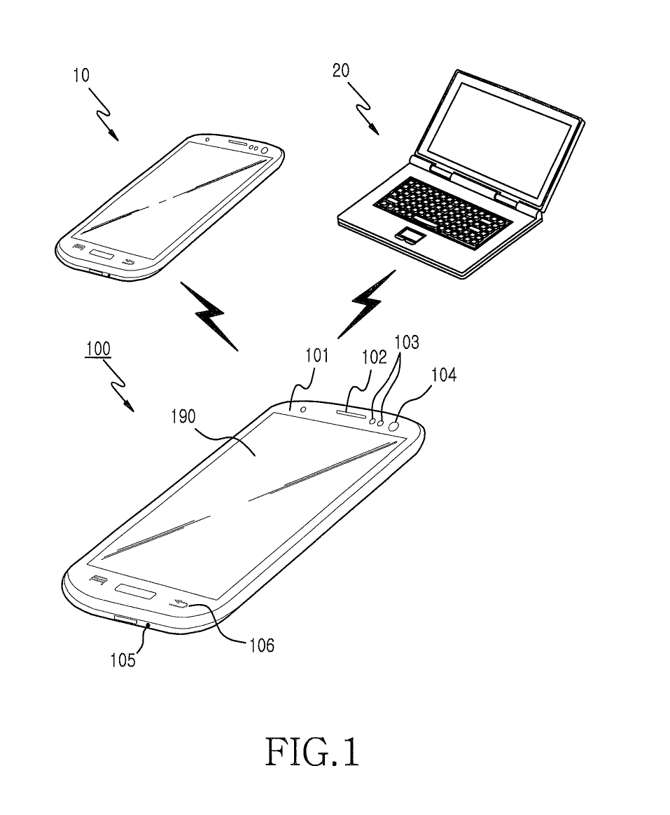

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. Also, descriptions of well-known functions and constructions are omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of exemplary embodiments of the present disclosure are provided for illustration purpose only and not for the purpose of limiting the disclosure as defined by the appended claims and their equivalents.

Though an electronic device that applies a touchpad as a display unit has been illustrated and described in describing embodiments of the present disclosure, it is not limited thereto. For example, various devices including a touchscreen, that is, a Personal Digital Assistant (PDA), a laptop computer, a mobile phone, a smartphone, a netbook, a Mobile Internet Device (MID), a Ultra Mobile Personal Computer (UMPC), a tablet PC, a note PC, a watch, a navigation, an MP3 player, a camera unit, or a wearable unit, etc. can be applied as the electronic device.

In an embodiment, a gesture means a touch pattern is formed on the touchscreen of the electronic device. A touch is formed on the touchscreen of the electronic device by an outside input means such as a user's finger or a touch pen, etc., and a gesture means a drag of a predetermined pattern is formed with a touch maintained on the touchscreen. Depending on cases, a gesture can mean a drag with a touch maintained and a release of the touch are performed.

Also, in an embodiment of the present disclosure, a terminology of a ‘gesture’ can mean movement of a user's hand controlling an electronic device. Examples of a gesture described in various embodiments of the present disclosure can include tapping, a touch and hold, double tapping, a drag, panning, flicking, and a drag and drop.

A terminology of ‘tapping’ can be understood as an operation where a user touches a screen in very high speed with his finger or a stylus. In other words, a terminology of ‘tapping’ means a case where a time interval between a touch-in and a touch-out is very short. A touch-in means a user touches the screen with his finger or a stylus, and a touch-out means the user takes off his finger or a stylus from the screen.

A terminology of ‘touch and hold’ means a user touches the screen with his finger or a stylus and maintains the touch for a threshold time duration or more. That, the terminology of ‘touch and hold’ means a time interval between a touch-in and a touch-out is equal to or greater than the threshold time duration. When a touch input is maintained for the threshold time duration or more, a video or audio feedback signal can be provided to a user so that the user can determine whether the touch input is a tapping operation or a touch and hold operation.

A terminology of ‘double tapping’ means a user touches the screen twice in fast speed using his finger or a stylus.

A terminology of ‘drag’ means a user touches one point of the screen with his finger or a stylus, and moves the finger or the stylus up to another point on the screen while maintaining the touch. The user can perform a drag to move an object or perform panning.

A terminology of ‘panning’ means performing a drag without selecting an object. Since an object is not selected while panning is performed, when panning is performed, a page moves inside the screen, or an object group, not a single object can move inside a page.

A terminology of ‘flicking’ means a user drags in high speed using his finger or a stylus. A drag (or panning) and flicking can be discriminated from each other depending on whether speed in which a finger or a stylus moves is equal to or greater than a threshold speed.

A terminology of ‘drag and drop’ means a user drags an object up to a desired position on the screen using his finger or a stylus, and then takes off his finger or the stylus from the screen so that the object can be dropped at a position at which his finger or the stylus is taken off from the screen.

Also, a terminology of ‘hovering’ means an input method of recognizing a finger or a stylus when a user allows his finger or the stylus to approach a detection region without contacting the screen. Hovering is also called a proximity touch or a non-contact touch.

FIG. 1 is a perspective view illustrating an electronic device 100 according to an embodiment of the present disclosure.

Referring to FIG. 1, a touchscreen 190 can be installed to a front surface 101 of the electronic device 100. The touchscreen 190 can display an electric signal transferred from the electronic device 100 in the form of text, graphics, an image such as a video, etc. Also, the touchscreen 190 can apply a touch sensor to perform data input/output simultaneously. For example, the touchscreen 190 can receive a gesture input pattern via an input means such as a finger or a stylus.

According to an embodiment, the gesture input pattern can be an operation of performing one of flicking, a touch and drag, tap and hold, and a multi tap. However, the gesture input pattern is not limited thereto but can include a drawing input pattern or a hovering input pattern.

An ear piece 102 for receiving voice can be installed to the upper portion of the touchscreen 190, and a plurality of sensors 103 such as a proximity sensor or an luminance sensor and a camera unit 104 for shooting an object can be installed to the right of the ear piece 102.

According to an embodiment of the present disclosure, the electronic device 100 can further include a microphone unit 105 positioned at the lower portion of the touchscreen 190, for receiving sounds, and a keypad unit 106 where key buttons are disposed. However, the electronic device 100 is not limited thereto and various additional units for implementing other known additional functions can be further installed.

According to another embodiment, the electronic device 100 can receive a voice input pattern besides the gesture input pattern. For example, the voice input pattern can be a voice input pattern similar to a predetermined voice pattern. The electronic device 100 can generate a pattern ID via the gesture input pattern or the voice input pattern, and perform wireless connection with counterpart electronic devices 10 and 20 such as a smartphone and a laptop computer using this pattern ID.

According to the present embodiment, the electronic device 100 can perform wireless communication with one or more counterpart electronic devices, or two or more counterpart electronic devices. Various devices such as a PDA, a laptop computer, a mobile phone, a smartphone, a net book, an MID, a UMPC, a tablet PC, a note PC, a watch, a navigation, an MP3 player, a camera unit, or a wearable unit can be applied as the counterpart electronic device.

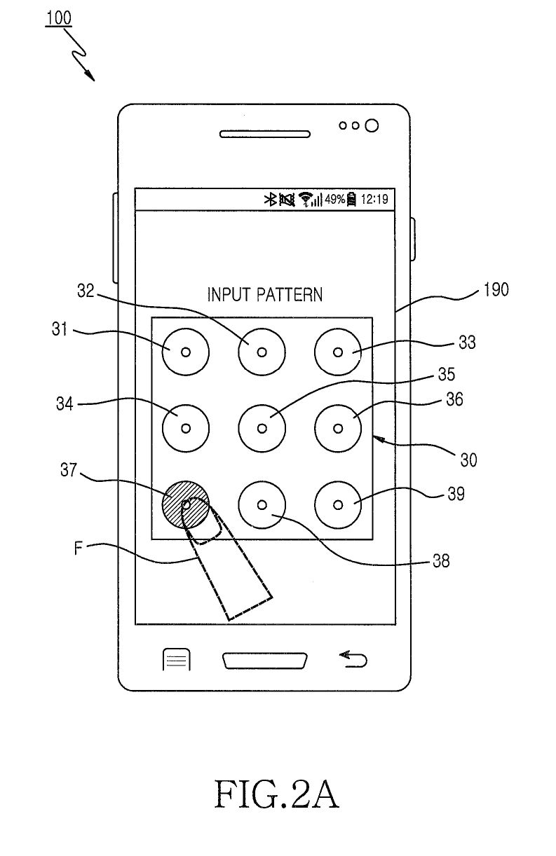

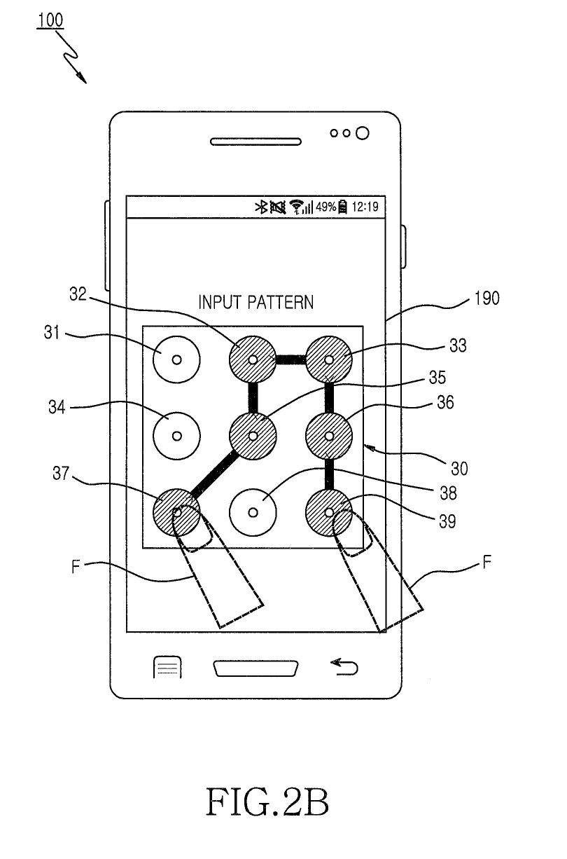

FIGS. 2A and 2B are views illustrating a method for receiving an input pattern of an electronic device according to an embodiment of the present disclosure.

Referring to FIGS. 2A and 2B, the electronic device can receive a gesture input pattern via the touchscreen 190. The gesture input pattern can be an operation of performing one of flicking, a touch and drag, a tap and hold, a multi tap on the touchscreen 190. Also, the gesture input pattern can be various input patterns using a drawing input pattern or a hovering input pattern.

According to an embodiment, the electronic device 100 can display a drawing pattern 30 configured in a grid form on the touchscreen 190. The drawing pattern 130 can be configured using a plurality of objects 31, 32, 33, 34, 35, 36, 37, 38, 39, which can be disposed with a constant interval or at a specific position. The plurality of objects 31, 32, 33, 34, 35, 36, 37, 38, 39 included in the drawing pattern 30 can include unique data values, respectively.

According to an embodiment, a first object 31 of the drawing pattern 30 can have a data value of a number ‘1’, and a second object 32 can have a data value of a number ‘2’. In this manner, the third, fourth, fifth, sixth, seventh, eighth, ninth objects 33, 34, 35, 36, 37, 38, 39 have data values of numbers ‘3’, ‘4’, ‘5’, ‘6’, ‘7’, ‘8’, ‘9’. However, it is not limited thereto, and for example, the first object 31 can have a data value of a character ‘A’, and the second object 32 can have a data value of a character ‘B’, and various text data values can be included in this manner.

As illustrated in FIG. 2B, in case of dragging the drawing pattern 30 on the touchscreen 190 using an input means such as a finger F or a stylus, objects 32, 33, 35, 36, 37, 39 touched by the drag can be displayed such that they are discriminated from untouched objects 31, 34, 38. The electronic device 100 can store the unique data values 2, 3, 5, 6, 7, 9 included in the touched objects 32, 33, 35, 36, 37, 39 as an input pattern according to the dragged sequence. For example, since the dragged sequence is a sequence of the starting seventh object 37, the fifth object 35, the second object 32, the third object 33, the sixth object 36, and the ninth object 39, the electronic device 100 can obtain an input pattern of ‘752369’ using the above method. However, it is not limited thereto, but the electronic device 100 can obtain an input pattern of various character strings.

According to another embodiment, the electronic device 100 can generate a pattern ID using the input pattern 752369 obtained by the drawing pattern 30. For example, the electronic device 100 can arbitrarily combine the obtained input pattern 752369 to regenerate a pattern ID. In this manner, various pattern IDs of ‘679532’, ‘723596’, ‘259673’, etc. can be generated.

The electronic device 100 can retrieve a counterpart electronic device having a counterpart ID corresponding to this pattern, and perform wireless communication with the counterpart electronic device. The electronic device 100 can be connected with the counterpart electronic device via various short distance communication schemes. For example, a Peer to Peer (P2P) Bluetooth or a Wi Fi Direct scheme can be applied, and the electronic device 100 can be connected with the counterpart electronic device in a pairing method. However, it is not limited thereto, and the electronic device 100 can perform various P2P wireless communications with the counterpart electronic device.

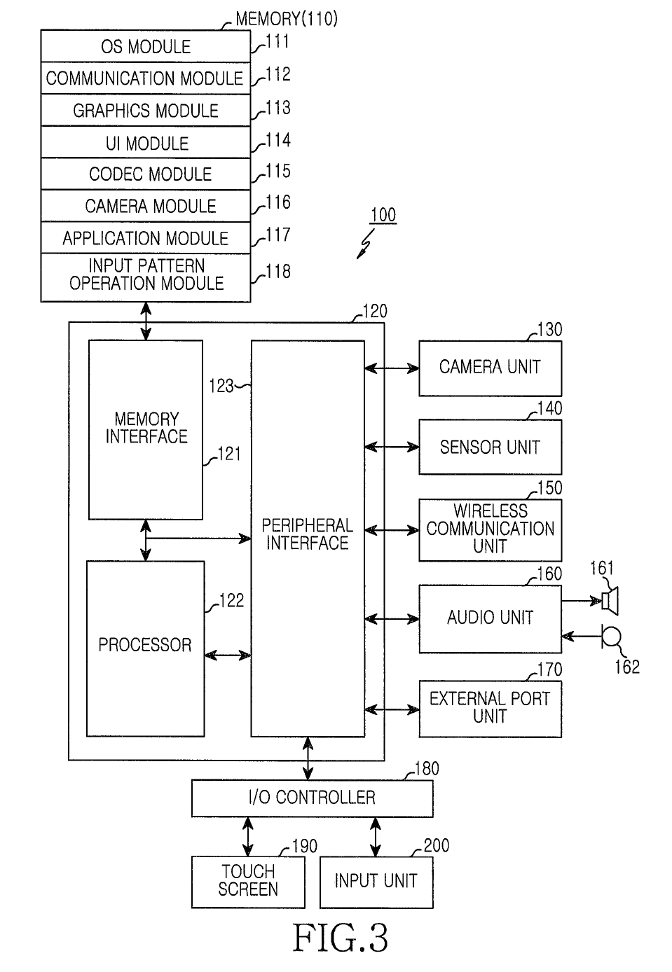

FIG. 3 is a block diagram illustrating an electronic device according to an embodiment of the present disclosure.

Referring to FIG. 3, the electronic device 100 can be a device such as a PDA, a laptop computer, a mobile phone, a smartphone, a net book, a handheld computer, an MID, a media player, a UMPC, a tablet PC, a note PC, a watch, a navigation, an MP3 player, a camera unit, etc. The electronic device 100 can be an arbitrary device including two or more functions among these devices.

The electronic device 100 can include a memory 110, a processor unit 120, a camera unit 130, a sensor unit 140, a wireless communication unit 150, an audio unit 160, an external port unit 170, an Input/Output (I/O) controller 180, a touchscreen 190, and an input unit 200. Also, a plurality of memories 110 and external ports 170 can be provided.

Each of the elements is described below.

The processor unit 120 includes a memory interface 121, at least one processor 122, and a peripheral interface 123. Here, the memory interface 121, the at least one processor 122, and the peripheral interface 123 included in the processor unit 120 can be integrated in at least one integrated circuit or implemented as separate elements.

The memory interface 121 can control an access of elements such as the processor 122 or the peripheral interface 123 to the memory 110.

The peripheral interface 123 can control connection between I/O peripherals of the electronic device 100, and the processor 122 and the memory interface 121.

The processor 122 can control the electronic device 100 to provide various multimedia services using at least one software program. At this point, the processor 122 can execute at least one program stored in the memory 110 to provide a service corresponding to a relevant program.

The processor 122 can execute various software programs to perform various functions for the electronic device 100, and performs a process and a control for voice communication, video communication, and data communication. The processor 122 can perform the methods according to various embodiments of the present disclosure in cooperation with software modules stored in the memory 110.

According to an embodiment, the processor can identify a pattern ID from an input pattern received in the electronic device 100, retrieve a counterpart electronic device having the pattern ID, and perform wireless connection with the retrieved counterpart electronic device having the counterpart ID.

The processor 122 can include one or more data processors, image processors, or a CODEC. Furthermore, the electronic device 100 can configure a data processor, an image processor, or a CODEC, separately.

The camera unit 130 can perform a camera function such as a photo, video clip recording, etc. The camera unit 130 can include a Charge Coupled Device (CCD) or a Complementary Metal Oxide Semiconductor (CMOS). Also, the camera unit 130 can change hardware configuration, for example, control lens movement, a number of an aperture, etc. depending on a camera program executed by the processor 122.

Various elements of the electronic device 100 can be connected via one or more communication buses (reference numeral not shown) or electric connection means (reference numeral not shown).

The sensor unit 140 can include a proximity sensor, a Hall sensor, an luminance sensor, a motion sensor, etc. The proximity sensor can detect an object approaching the electronic device 100, and the Hall sensor can detect magnetic force of a metal body. The luminance sensor can detect ambient light and the motion sensor can detect movement of the electronic device 100. For example, the sensor unit 140 can detect movement of the electronic device 100 to store the same as an input pattern.

The wireless communication unit 150 enables wireless communication, and can include a Radio Frequency (RF) transmitter/receiver or a light (for example, infrared) transmitter/receiver. The wireless communication unit 150 can be designed to operate via at least one of a GSM network, an EDGE network, a CDMA network, a W-CDMA network, an LTE network, an OFDMA network, a Wi-Fi network, a WiMax network, an NFC network, and a Bluetooth network depending on a communication network.

The audio unit 160 can be connected to a speaker 161 and a microphone 162 to take change of voice recognition, voice duplication, digital recording, or audio input/output such as a communication function. The audio unit 160 can provide an audio interface between a user and the electronic device 100, receive a data signal from the processor unit 120, convert the received data signal to an electric signal, and output the converted electric signal via the speaker 161.

The speaker 161 can convert an electric signal to an audible frequency band and output the same, and be disposed in the front or the rear of the electronic device 100. The speaker 161 can include a flexible film speaker where at least one piezoelectric body has been attached to one vibration film.

The microphone 162 can convert a sound wave transferred from a person or other sound sources to an electric signal. Also, the audio unit 160 can receive an electric signal from the microphone 162, convert the received electric signal to an audio data signal, and transmit the converted audio data signal to the processor unit 120. The audio unit 160 can include an earphone, an ear set, or a headset detachable from the electronic device 100.

According to an embodiment, the audio unit 160 can receive a user's voice to store the same as a voice input pattern. In this case, the audio unit 160 can provide the voice input pattern to the processor 122, and the processor 122 can identify a pattern ID with reference to a voice data value stored in advance in the memory 110 of the electronic device 100.

The external port unit 170 can directly connect the electronic device 100 with a counterpart electronic device, or indirectly connect the electronic device 100 with a counterpart electronic device via a network (for example, the Internet, an Intranet, a wireless LAN, etc.).

The I/O controller 180 can provide an interface between an input/output unit such as the touchscreen 190 and the input unit 200, and the peripheral interface 123.

The touchscreen 190 can provide an input and output interface between the electronic device 100 and a user. For example, the touchscreen 190 can apply a touch detect technology, transfer a user's touch input to the processor unit 120, and show visual information, text, graphics or video, etc. provided from the processor unit 120 to a user.

The touchscreen 190 can display state information of the electronic device 100, a character input by a user, a moving picture, and a still picture, etc. The touchscreen 190 can display information of an application driven by the processor 122.

The touchscreen 190 can further apply an arbitrary multi-touch detect technology including other proximity sensor arrangements or other elements as well as capacitive, resistive, infrared, and surface acoustic wave technologies. The touchscreen 190 can apply at least one of a Liquid Crystal Display (LCD), an Organic Light Emitting Diode (OLED), an Active Matrix Organic Light Emitting Diode (AMOLED), a flexible display, and a 3 dimensional display.

According to an embodiment, the touchscreen 190 can receive a gesture input pattern via an input means such as a finger or a stylus. This gesture input pattern can be an operation of performing one of flicking, a touch and drag, a tap and hold, a multi-tap on the touchscreen 190. However, it is not limited thereto but the gesture input pattern can include a drawing input pattern or a hovering input pattern. The touchscreen 190 can provide the gesture input pattern received in the above method to the processor 122.

The input unit 200 can provide input data generated by a user's selection to the processor 122 via the I/O controller 180. At this point, the input unit 200 can include a keypad including at least one hardware button and a touchpad for detecting touch information. The input unit 200 can include an up/down button for volume control. Besides, the input unit 200 can include at least one of a push button, a locker button, a locker switch, a thumb-wheel, a dial, a stick, and a pointer device such as a stylus to which a relevant function is given.

The memory 110 can include a high speed random access memory such as one or more magnetic disk storages, or a non-volatile memory, one or more optical storages, or a flash memory (for example, NAND, NOR). The memory 110 stores a software. The software can include an Operating System (OS) module 111, a communication module 112, a graphics module 113, a User Interface (UI) module 114, a CODEC module 115, a camera module 116, an application module 117, and an input pattern operation module 118. A terminology of a module can be expressed as a set of instructions, an instruction set, or a program.

The OS module 111 can include WINDOWS™, LINUX™, Darwin™, RTXC™, UNIX™, OS X™, or a built-in operating system such as VxWorks, and include various software elements for controlling a general system operation. The control of this general system can include memory control and management, storage hardware (device) control and management, power control and management, etc. The OS module 111 can also perform a function for swift communication between various hardwares (devices) and software elements (modules).

The communication module 112 can enable communication with a counterpart electronic device such as a computer, a server, and another electronic device via the wireless communication unit 150 or the external port unit 170.

The graphics module 113 can include various software elements for providing and displaying graphics to the touchscreen 190. A terminology of graphics can mean text, a web page, an icon, a digital image, video, an animation, etc.

The UI module 114 can include various software elements related to a M. The UI module 114 can control to display information of an application driven by the processor 122 on the touchscreen 190. Also, the UI module 114 can include content regarding how the state of the UI changes or under what condition the state of the UI changes.

The CODEC module 115 can include a software element related to encoding and decoding of a video file.

The camera module 116 can include a camera-related software element enabling camera-related processes and functions.

The application module 117 can include a software element regarding at least one application installed to the electronic device 100. The application can include a browser, an e-mail, a phonebook, games, a short message service, a multimedia message service, a Social Network Service (SNS), an instant message, a morning call, an MP3 player, a schedule management, a camera, word processing, keyboard emulation, an address book, a contact list, a widget, a Digital Right Management (DRM), voice recognition, voice duplication, a position determining function, or a position-based service, etc.

The input pattern operation module 118 can include a software element for generating a pattern ID for a received input pattern. The input pattern operation module 118 has respective unique data values for a gesture input pattern and a voice input pattern, and can support to generate a pattern ID using the unique data value. However, it is not limited thereto but can have data values for various types of input patterns, and include various routines for generating a related process controlling an input pattern, and a pattern ID.

The processor unit 120 can further include an additional module (instructions) besides the above-described modules. Also, various functions of the electronic device 100 according to various embodiments of the present disclosure can include a hardware including one or more processings or an Application Specific Integrated Circuit (ASIC), or a software.

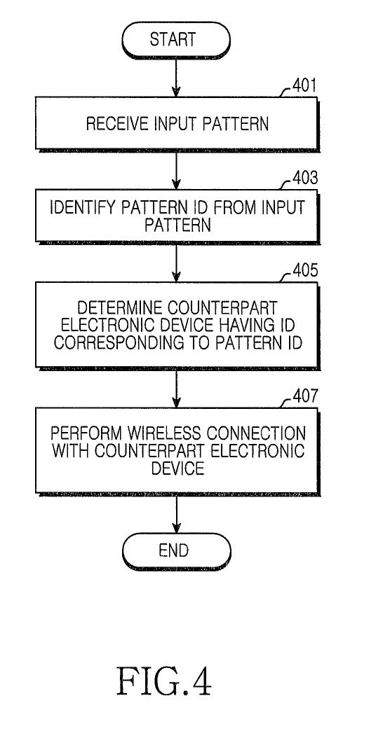

FIG. 4 is a flowchart illustrating a method for operating an electronic device according to an embodiment of the present disclosure.

Referring to FIG. 4, the electronic device 100 can receive an input pattern in step 401. According to an embodiment, the electronic device 100 can receive a gesture input pattern or a voice input pattern. For example, the electronic device 100 can receive a gesture input pattern from the touchscreen 190 via an input means such as a finger or a stylus. This gesture input pattern can be an operation of performing one of flicking, a touch and drag, a tap and hold, and a multi-tap on the touchscreen 190. However, it is not limited thereto but the gesture input pattern can include a drawing input pattern or a hovering input pattern. The electronic device 100 can receive a voice input pattern besides the above-described gesture input pattern. For example, the voice input pattern can be a voice input pattern similar to a predetermined voice pattern.

As illustrated in FIG. 2B, the electronic device 100 can receive an input pattern via the drawing pattern 30, and generate an input pattern using unique data values of the objects 31, 32, 33, 34, 35, 36, 37, 38, 39 included in the drawing pattern 30. For example, in case of FIG. 2B, the electronic device 100 can generate a predetermined pattern such as ‘752369’ using unique data values 7, 5, 2, 3, 6, 9 included in the objects 37, 35, 32, 33, 36, 39 selected according to a drag sequence in the drawing pattern 30. However, it is not limited thereto and the objects 31, 32, 33, 34, 35, 36, 37, 38, 39 included in the drawing pattern 30 can have various data values, and an input pattern can be generated by various combinations.

Next, the electronic device 100 can identify a pattern ID from an input pattern in step 403. According to an embodiment, the electronic device 100 can regenerate a pattern ID by arbitrarily combining the input pattern 752369 received via the drawing pattern 30. Other pattern IDs ‘679532’, ‘723596’, ‘259673’ different from the above input pattern 752369 can be generated in this manner.

Next, the electronic device 100 can determine a counterpart electronic device having a ID corresponding to the pattern ID in step 405. According to an embodiment, the electronic device 100 can retrieve a counterpart electronic device having a counterpart ID using a short distance communication scheme. For example, the electronic device 100 can determine whether a counterpart ID is the same as the pattern ID or whether the same text is included.

Next, the electronic device 100 can perform wireless connection with the counterpart electronic device in step 407. According to an embodiment, the electronic device 100 can make a communication allowed state by pairing with the counterpart electronic device having the counterpart ID. For example, the electronic device 100 can apply a P2P Bluetooth scheme or a WiFi Direct scheme. However, it is not limited thereto, and the electronic device 100 can perform various types of P2P wireless communication with a counterpart electronic device.

An instruction set for each operation can be stored as one or more modules in the memory 110. In this case, the module stored in the memory 110 can be executed by one or more processors 122.

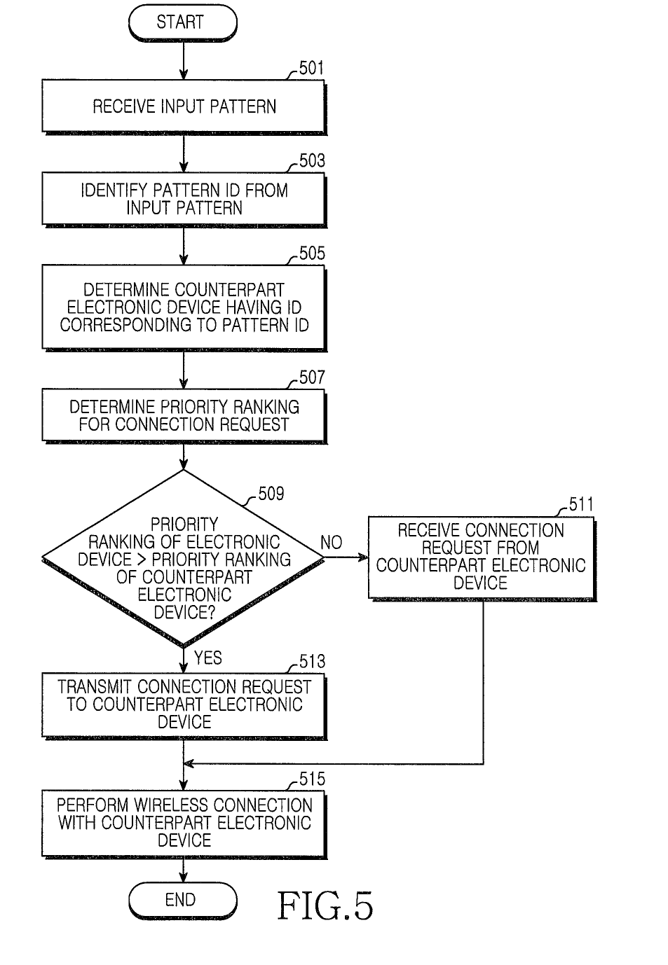

FIG. 5 is a flowchart illustrating a method for operating an electronic device according to another embodiment of the present disclosure.

Referring to FIG. 5, the electronic device 100 can receive an input pattern in step 501. According to an embodiment, the electronic device can receive a gesture input pattern or a voice input pattern. For example, the electronic device 100 can receive a gesture input pattern from the touchscreen 190 via an input means such as a finger or a stylus. This gesture input pattern can be an operation of performing one of flicking, a touch and drag, a tap and hold, and a multi-tap on the touchscreen 190. However, it is not limited thereto but the gesture input pattern can include a drawing input pattern or a hovering input pattern. The electronic device 100 can receive a voice input pattern besides the above-described gesture input pattern. For example, the voice input pattern can be a voice input pattern similar to a predetermined voice pattern.

As illustrated in FIG. 2B, the electronic device 100 can receive an input pattern via the drawing pattern 30, and generate an input pattern using unique data values of the objects 31, 32, 33, 34, 35, 36, 37, 38, 39 included in the drawing pattern 30. For example, in case of FIG. 2B, the electronic device 100 can generate a predetermined pattern such as ‘752369’ using unique data values 7, 5, 2, 3, 6, 9 included in the objects 37, 35, 32, 33, 36, 39 selected according to a drag sequence in the drawing pattern 30. However, it is not limited thereto and the objects 31, 32, 33, 34, 35, 36, 37, 38, 39 included in the drawing pattern 30 can have various data values, and an input pattern can be generated by various combinations.

Next, the electronic device 100 can identify a pattern ID from an input pattern in step 503. According to an embodiment, the electronic device 100 can regenerate a pattern ID by arbitrarily combining the input pattern 752369 received via the drawing pattern 30. Other pattern IDs ‘679532’, ‘723596’, ‘259673’ different from the above input pattern 752369 can be generated in this manner.

Next, the electronic device 100 can determine a counterpart electronic device having a ID corresponding to the pattern ID in step 505. According to an embodiment, the electronic device 100 can retrieve a counterpart electronic device having a counterpart ID using a short distance communication scheme. For example, the electronic device 100 can determine whether a counterpart ID is the same as the pattern ID or whether the same text is included.

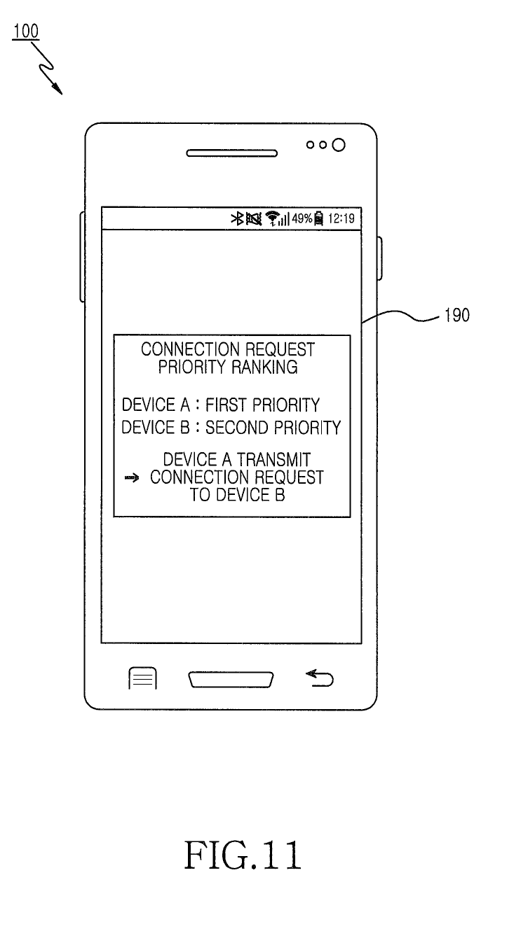

Next, the electronic device 100 can determine a priority ranking for a connection request in step 507. According to an embodiment, the electronic device 100 can transmit a connection request to a counterpart electronic device, and receive a connection request from the counterpart electronic device. For example, as illustrated in FIG. 11, the electronic device 100 or a counterpart electronic device whose priority ranking for a connection request is high can try a connection.

Next, the electronic device 100 can determine whether the priority ranking of the electronic device 100 is higher than the priority ranking of the counterpart electronic device in step 509. According to an embodiment, the priority ranking for a connection request can be determined according to an input pattern sequence input first. For example, the electronic device 100 can determine which input pattern sequence has been input first among the input pattern sequence of the electronic device 100 and the input pattern sequence of the counterpart electronic device.

In the case where the priority ranking of the electronic device 100 is smaller than the priority ranking of the counterpart electronic device, the electronic device 100 can receive a connection request from the counterpart electronic device in step 511.

Also, in the case where the priority ranking of the electronic device 100 is greater than the priority ranking of the counterpart electronic device, the electronic device 100 can transmit a connection request to the counterpart electronic device in step 513.

The electronic device 100 can perform wireless connection with the counterpart electronic device via step 511 or 513 (step 515). According to an embodiment, the electronic device 100 can make a communication allowed state by pairing with the counterpart electronic device. For example, the electronic device 100 can apply a P2P Bluetooth scheme or a WiFi Direct scheme. However, it is not limited thereto, and the electronic device 100 can perform various types of P2P wireless communication with a counterpart electronic device.

An instruction set for each operation can be stored as one or more modules in the memory 110. In this case, the module stored in the memory 110 can be executed by one or more processors 122.

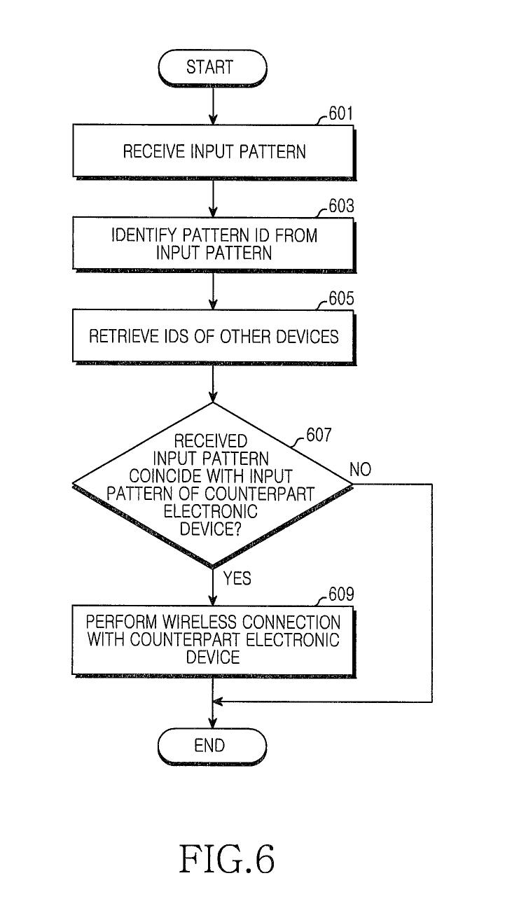

FIG. 6 is a flowchart illustrating a method for operating an electronic device 100 according to still another embodiment of the present disclosure.

Referring to FIG. 6, the electronic device 100 can receive an input pattern in step 601. According to an embodiment, the electronic device 100 can receive a gesture input pattern or a voice input pattern. For example, the electronic device 100 can receive a gesture input pattern from the touchscreen 190 via an input means such as a finger or a stylus. This gesture input pattern can be an operation of performing one of flicking, a touch and drag, a tap and hold, and a multi-tap on the touchscreen 190. However, it is not limited thereto but the gesture input pattern can include a drawing input pattern or a hovering input pattern. The electronic device 100 can receive a voice input pattern besides the above-described gesture input pattern. For example, the voice input pattern can be a voice input pattern similar to a predetermined voice pattern.

As illustrated in FIG. 2B, the electronic device 100 can receive an input pattern via the drawing pattern 30, and generate an input pattern using unique data values of the objects 31, 32, 33, 34, 35, 36, 37, 38, 39 included in the drawing pattern 30. For example, in case of FIG. 2B, the electronic device 100 can generate a predetermined pattern such as ‘752369’ using unique data values 7, 5, 2, 3, 6, 9 included in the objects 37, 35, 32, 33, 36, 39 selected according to a drag sequence in the drawing pattern 30. However, it is not limited thereto and the objects 31, 32, 33, 34, 35, 36, 37, 38, 39 included in the drawing pattern 30 can have various data values, and an input pattern can be generated by various combinations.

Next, the electronic device 100 can identify a pattern ID from an input pattern in step 603. According to an embodiment, the electronic device 100 can regenerate a pattern ID by arbitrarily combining the input pattern 752369 received via the drawing pattern 30. Other pattern IDs ‘679532’, ‘723596’, ‘259673’ different from the above input pattern 752369 can be generated in this manner.

Next, the electronic device 100 can retrieve IDs of other devices in step 605. According to an embodiment, the electronic device 100 can retrieve a counterpart electronic device having a counterpart ID using a short distance communication scheme. For example, the electronic device 100 can determine whether a counterpart ID is the same as the pattern ID or whether the same text is included.

Next, the electronic device 100 can determine whether a received input pattern coincides with an input pattern of the counterpart electronic device in step 607. According to an embodiment, the electronic device 100 can determine whether a received gesture input pattern coincides with a gesture input pattern received from the counterpart electronic device, or determine a degree in which the received voice input pattern is similar to the voice input pattern received from the counterpart electronic device.

In the case where the received input pattern coincides with the input pattern of the counterpart electronic device, the electronic device 100 can perform wireless connection with the counterpart electronic device in step 609. According to an embodiment, the electronic device 100 can make a communication allowed state by pairing with the counterpart electronic device. For example, the electronic device 100 can apply a P2P Bluetooth scheme or a WiFi Direct scheme. However, it is not limited thereto, and the electronic device 100 can perform various types of P2P wireless communication with a counterpart electronic device.

An instruction set for each operation can be stored as one or more modules in the memory 110. In this case, the module stored in the memory 110 can be executed by one or more processors 122.

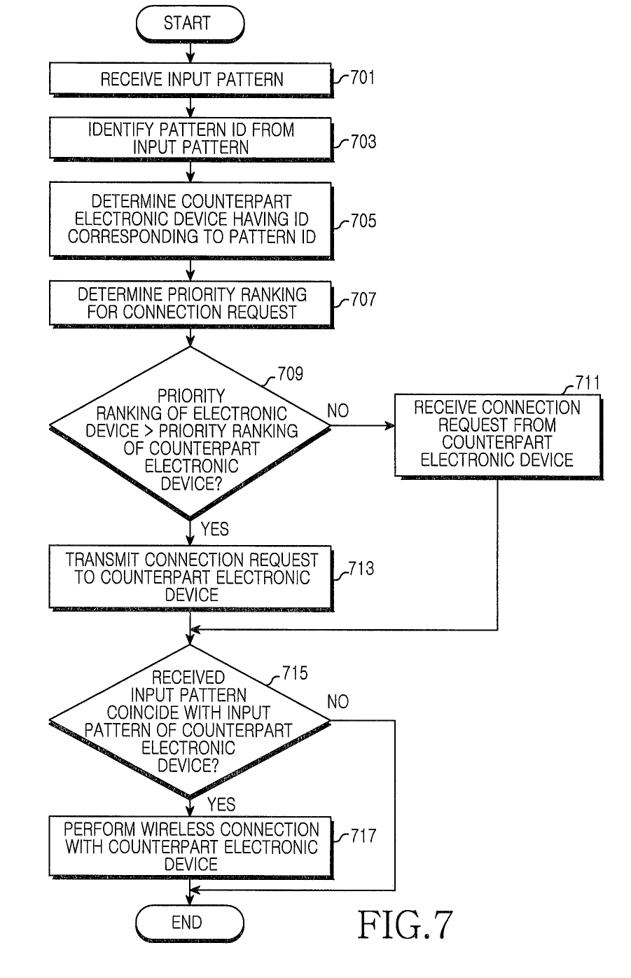

FIG. 7 is a flowchart illustrating a method for operating an electronic device according to various embodiments of the present disclosure.

Referring to FIG. 7, the electronic device 100 can receive an input pattern in step 701. According to an embodiment, the electronic device 100 can receive a gesture input pattern or a voice input pattern. For example, the electronic device 100 can receive a gesture input pattern from the touchscreen 190 via an input means such as a finger or a stylus. This gesture input pattern can be an operation of performing one of flicking, a touch and drag, a tap and hold, and a multi-tap on the touchscreen 190. However, it is not limited thereto but the gesture input pattern can include a drawing input pattern or a hovering input pattern. The electronic device 100 can receive a voice input pattern besides the above-described gesture input pattern. For example, the voice input pattern can be a voice input pattern similar to a predetermined voice pattern.

As illustrated in FIG. 2B, the electronic device 100 can receive an input pattern via the drawing pattern 30, and generate an input pattern using unique data values of the objects 31, 32, 33, 34, 35, 36, 37, 38, 39 included in the drawing pattern 30. For example, in case of FIG. 2B, the electronic device 100 can generate a predetermined pattern such as ‘752369’ using unique data values 7, 5, 2, 3, 6, 9 included in the objects 37, 35, 32, 33, 36, 39 selected according to a drag sequence in the drawing pattern 30. However, it is not limited thereto and the objects 31, 32, 33, 34, 35, 36, 37, 38, 39 included in the drawing pattern 30 can have various data values, and an input pattern can be generated by various combinations.

Next, the electronic device 100 can identify a pattern ID from an input pattern in step 703. According to an embodiment, the electronic device 100 can regenerate a pattern ID by arbitrarily combining the input pattern 752369 received via the drawing pattern 30. Other pattern IDs ‘679532’, ‘723596’, ‘259673’ different from the above input pattern 752369 can be generated in this manner.

Next, the electronic device 100 can determine a counterpart electronic device having a ID corresponding to the pattern ID in step 705. According to an embodiment, the electronic device 100 can retrieve a counterpart electronic device having a counterpart ID using a short distance communication scheme. For example, the electronic device 100 can determine whether a counterpart ID is the same as the pattern ID or whether the same text is included.

Next, the electronic device 100 can determine a priority ranking for a connection request in step 707. According to an embodiment, the electronic device 100 can transmit a connection request to a counterpart electronic device, and receive a connection request from the counterpart electronic device. For example, as illustrated in FIG. 11, the electronic device 100 or a counterpart electronic device whose priority ranking for a connection request is high can try a connection.

Next, the electronic device 100 can determine whether the priority ranking of the electronic device 100 is higher than the priority ranking of the counterpart electronic device in step 709. According to an embodiment, the priority ranking for a connection request can be determined according to an input pattern sequence input first. For example, the electronic device 100 can determine which input pattern sequence has been input first among the input pattern sequence of the electronic device 100 and the input pattern sequence of the counterpart electronic device.

In the case where the priority ranking of the electronic device 100 is smaller than the priority ranking of the counterpart electronic device, the electronic device 100 can receive a connection request from the counterpart electronic device in step 711.

Also, in the case where the priority ranking of the electronic device 100 is greater than the priority ranking of the counterpart electronic device, the electronic device 100 can transmit a connection request to the counterpart electronic device in step 713.

Next, the electronic device 100 can determine whether the input pattern received in step 715 coincides with an input pattern of a counterpart electronic device. According to an embodiment of the present disclosure, the electronic device 100 can determine whether a received gesture input pattern coincides with a gesture input pattern received from the counterpart electronic device, or determine a degree in which a received voice input pattern is similar to a voice input pattern received from the counterpart electronic device.

In the case where a received input pattern coincides with an input pattern of the counterpart electronic device, the electronic device 100 can perform wireless connection with the counterpart electronic device in step 717. According to an embodiment, the electronic device 100 can make a communication allowed state by pairing with the counterpart electronic device. For example, the electronic device 100 can apply a P2P Bluetooth scheme or a WiFi Direct scheme. However, it is not limited thereto, and the electronic device 100 can perform various types of P2P wireless communication with a counterpart electronic device.

An instruction set for each operation can be stored as one or more modules in the memory 110. In this case, the module stored in the memory 110 can be executed by one or more processors 122.

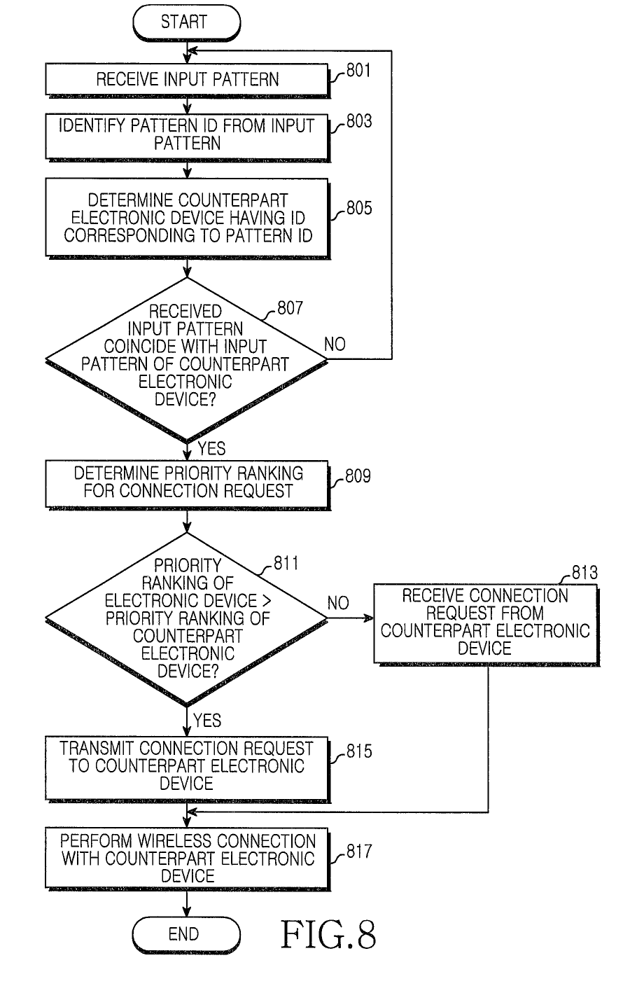

FIG. 8 is a flowchart illustrating a method for operating an electronic device according to various embodiments of the present disclosure.

Referring to FIG. 8, the electronic device 100 can receive an input pattern in step 801. According to an embodiment, the electronic device 100 can receive a gesture input pattern or a voice input pattern. For example, the electronic device 100 can receive a gesture input pattern from the touchscreen 190 via an input means such as a finger or a stylus. This gesture input pattern can be an operation of performing one of flicking, a touch and drag, a tap and hold, and a multi-tap on the touchscreen 190. However, it is not limited thereto but the gesture input pattern can include a drawing input pattern or a hovering input pattern. The electronic device 100 can receive a voice input pattern besides the above-described gesture input pattern. For example, the voice input pattern can be a voice input pattern similar to a predetermined voice pattern.

As illustrated in FIG. 2B, the electronic device 100 can receive an input pattern via the drawing pattern 30, and generate an input pattern using unique data values of the objects 31, 32, 33, 34, 35, 36, 37, 38, 39 included in the drawing pattern 30. For example, in case of FIG. 2B, the electronic device 100 can generate a predetermined pattern such as ‘752369’ using unique data values 7, 5, 2, 3, 6, 9 included in the objects 37, 35, 32, 33, 36, 39 selected according to a drag sequence in the drawing pattern 30. However, it is not limited thereto and the objects 31, 32, 33, 34, 35, 36, 37, 38, 39 included in the drawing pattern 30 can have various data values, and an input pattern can be generated by various combinations.

Next, the electronic device 100 can identify a pattern ID from an input pattern in step 803. According to an embodiment, the electronic device 100 can regenerate a pattern ID by arbitrarily combining the input pattern 752369 received via the drawing pattern 30. Other pattern IDs ‘679532’, ‘723596’, ‘259673’ different from the above input pattern 752369 can be generated in this manner.

Next, the electronic device 100 can determine a counterpart electronic device having a ID corresponding to the pattern ID in step 805. According to an embodiment, the electronic device 100 can retrieve a counterpart electronic device having a counterpart ID using a short distance communication scheme. For example, the electronic device 100 can determine whether a counterpart ID is the same as the pattern ID or whether the same text is included.

Next, the electronic device 100 can determine whether a received input pattern coincides with an input pattern of the counterpart electronic device in step 807. According to an embodiment, the electronic device 100 can determine whether a received gesture input pattern coincides with a gesture input pattern received from the counterpart electronic device, or determine a degree in which a received voice input pattern is similar to a voice input pattern received from the counterpart electronic device.

In the case where the received input pattern coincides with an input pattern of the counterpart electronic device, the electronic device 100 can determine a priority ranking for a connection request in step 809. According to an embodiment, the electronic device 100 can transmit a connection request to a counterpart electronic device, and receive a connection request from the counterpart electronic device. For example, as illustrated in FIG. 11, the electronic device 100 or a counterpart electronic device whose priority ranking for a connection request is high can try a connection.

Next, the electronic device 100 can determine whether the priority ranking of the electronic device 100 is higher than the priority ranking of the counterpart electronic device in step 811. According to an embodiment, the priority ranking for a connection request can be determined according to an input pattern sequence input first. For example, the electronic device 100 can determine which input pattern sequence has been input first among the input pattern sequence of the electronic device 100 and the input pattern sequence of the counterpart electronic device.

In the case where the priority ranking of the electronic device 100 is smaller than the priority ranking of the counterpart electronic device, the electronic device 100 can receive a connection request from the counterpart electronic device in step 813.

Also, in the case where the priority ranking of the electronic device 100 is greater than the priority ranking of the counterpart electronic device, the electronic device 100 can transmit a connection request to the counterpart electronic device in step 815.

The electronic device 100 can perform wireless connection with a counterpart electronic device in step 813 or 815 (step 817).

According to an embodiment, the electronic device 100 can make a communication allowed state by pairing with the counterpart electronic device. For example, the electronic device 100 can apply a P2P Bluetooth scheme or a WiFi Direct scheme. However, it is not limited thereto, and the electronic device 100 can perform various types of P2P wireless communication with a counterpart electronic device.

An instruction set for each operation can be stored as one or more modules in the memory 110. In this case, the module stored in the memory 110 can be executed by one or more processors 122.

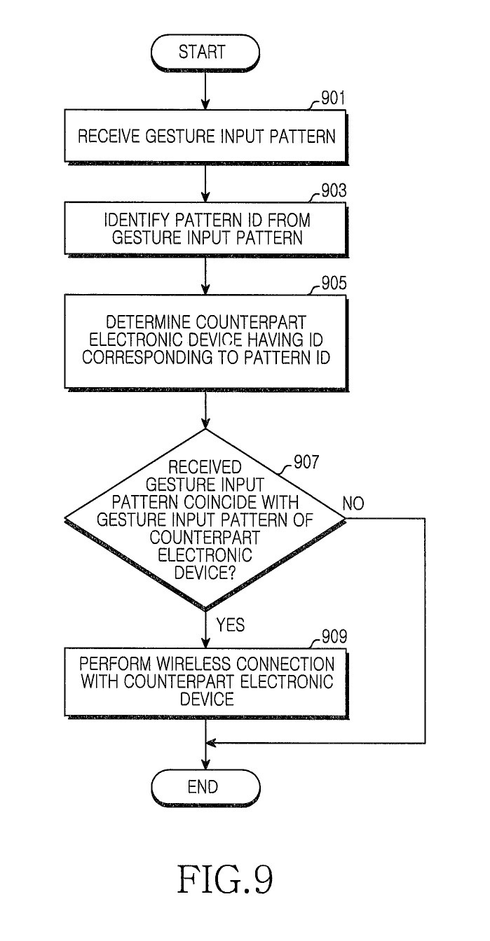

FIG. 9 is a flowchart illustrating a method for operating an electronic device according to various embodiments of the present disclosure.

Referring to FIG. 9, the electronic device 100 can receive a gesture input pattern in step 901. For example, the electronic device 100 can receive a gesture input pattern from the touchscreen 190 via an input means such as a finger or a stylus. This gesture input pattern can be an operation of performing one of flicking, a touch and drag, a tap and hold, and a multi-tap on the touchscreen 190. However, it is not limited thereto but the gesture input pattern can include a drawing input pattern or a hovering input pattern.

As illustrated in FIG. 2B, the electronic device 100 can receive a gesture input pattern via the drawing pattern 30, and generate a gesture input pattern using unique data values of the objects 31, 32, 33, 34, 35, 36, 37, 38, 39 included in the drawing pattern 30. For example, in case of FIG. 2B, the electronic device 100 can generate a predetermined pattern such as ‘752369’ using unique data values 7, 5, 2, 3, 6, 9 included in the objects 37, 35, 32, 33, 36, 39 selected according to a drag sequence in the drawing pattern 30. However, it is not limited thereto and the objects 31, 32, 33, 34, 35, 36, 37, 38, 39 included in the drawing pattern 30 can have various data values, and a gesture input pattern can be generated by various combinations.

Next, the electronic device 100 can identify a pattern ID from a gesture input pattern in step 903. According to an embodiment, the electronic device 100 can regenerate a pattern ID by arbitrarily combining the gesture input pattern 752369 received via the drawing pattern 30. Other pattern IDs ‘679532’, ‘723596’, ‘259673’ different from the above gesture input pattern 752369 can be generated in this manner.

Next, the electronic device 100 can determine a counterpart electronic device having a ID corresponding to the pattern ID in step 905. According to an embodiment, the electronic device 100 can retrieve a counterpart electronic device having a counterpart ID using a short distance communication scheme. For example, the electronic device 100 can determine whether a counterpart ID is the same as the pattern ID or whether the same text is included.

Next, the electronic device 100 can determine whether a received gesture input pattern coincides with a gesture input pattern of the counterpart electronic device in step 907.

In the case where the received gesture input pattern coincides with the gesture input pattern of the counterpart electronic device, the electronic device 100 can perform wireless connection with the counterpart electronic device in step 909. According to an embodiment, the electronic device 100 can make a communication allowed state by pairing with the counterpart electronic device. For example, the electronic device 100 can apply a P2P Bluetooth scheme or a WiFi Direct scheme. However, it is not limited thereto, and the electronic device 100 can perform various types of P2P wireless communication with a counterpart electronic device.

An instruction set for each operation can be stored as one or more modules in the memory 110. In this case, the module stored in the memory 110 can be executed by one or more processors 122.

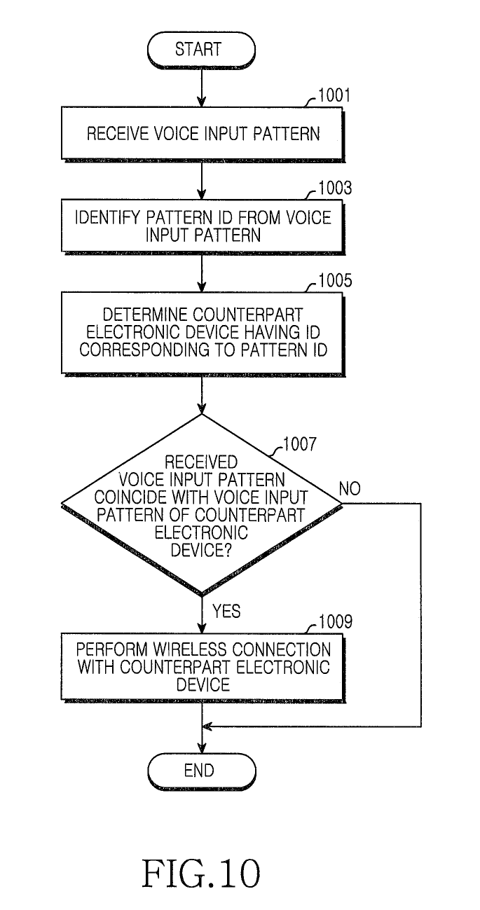

FIG. 10 is a flowchart illustrating a method for operating an electronic device according to various embodiments of the present disclosure.

Referring to FIG. 10, the electronic device 100 can receive a voice input pattern in step 1001. According to an embodiment, the voice input pattern can be a voice input pattern similar to a predetermined voice pattern. For example, an audio unit of the electronic device 100 can receive this voice input pattern.

Next, the electronic device 100 can identify a pattern ID from the voice input pattern in step 1003. According to an embodiment, the electronic device 100 can generate a pattern ID by combining data values received via the voice pattern.

Next, the electronic device 100 can determine a counterpart electronic device having a ID corresponding to the ID in step 1005. According to an embodiment, the electronic device 100 can retrieve a counterpart electronic device having a counterpart ID using a short distance communication scheme. For example, the electronic device 100 can determine whether a counterpart ID is the same as the pattern ID or whether the same text is included.

Next, the electronic device 100 can determine whether the received voice input pattern coincides with a voice input pattern of the counterpart electronic device in step 1007. For example, the electronic device 100 can determine a degree in which the received voice input pattern is similar to the voice input pattern received from the counterpart electronic device.

In the case where the received voice input pattern coincides with the voice input pattern of the counterpart electronic device, the electronic device 100 can perform wireless communication with the counterpart electronic device in step 1009. According to an embodiment, the electronic device 100 can make a communication allowed state by pairing with the counterpart electronic device. For example, the electronic device 100 can apply a P2P Bluetooth scheme or a WiFi Direct scheme. However, it is not limited thereto, and the electronic device 100 can perform various types of P2P wireless communication with a counterpart electronic device.

An instruction set for each operation can be stored as one or more modules in the memory 110. In this case, the module stored in the memory 110 can be executed by one or more processors 122.

According to an embodiment of the present disclosure, each of modules can be configured in a software, a firmware, a hardware, or a combination thereof. All or a portion of a module can be configured in one entity and can perform the function of each module. According to an embodiment of the present disclosure, respective operations can be executed sequentially, repetitively, or in parallel. Some of operations can be omitted or other operations can be added and executed. For example, respective operations can be executed by a corresponding module described by the present disclosure.

In case of implementation in the form of a software, a computer readable storage medium for storing one ore more programs (software modules) can be provided. One or more programs stored in the computer readable storage medium are configured for execution by one or more processors inside the electronic device. One or more programs can include instructions for enabling the electronic device to execute the methods according to the various embodiments of the present disclosure.

This program (a software module, a software) can be stored in Random Access Memory (RAM), a non-volatile memory including a flash memory, Read Only Memory (ROM), an Electrically Erasable Programmable Read Only Memory (EEPROM), a magnetic disc storage device, a Compact Disc (CD)-ROM, Digital Versatile Discs (DVDs), or other types of optical storage devices, and a magnetic cassette. Alternatively, the program can be stored in a memory configured by a portion or all of these. Also, a plurality of respective element memories can be provided.

The program can be stored in an attachable storage accessible to the electronic device via a communication network such as the Internet, an Intranet, a Local Area Network (LAN), Wide LAN (WLAN), or SAN, or a communication network configured in a combination of these. The storage can access the electronic device via an external port.

Also, a separate storage on a communication network can access a portable electronic device.

Although the disclosure has been shown and described with reference to certain exemplary embodiments thereof, it will be understood by those skilled in the art that various changes in form and details may be made therein without departing from the spirit and scope of the disclosure as defined by the appended claims and their equivalents. Therefore, the scope of the present disclosure should not be limited to the above-described embodiments but should be determined by not only the appended claims but also the equivalents thereof.

What is claimed is:

1. A method in an electronic device, the method comprising:
receiving an input pattern;
identifying a pattern identification (ID) from the input pattern;
determining a counterpart electronic device corresponding to the pattern ID; and
establishing a wireless connection with the corresponding electronic device.

2. The method of claim 1, wherein the input pattern comprises a gesture input pattern.

3. The method of claim 1, wherein the input pattern comprises a voice input pattern.

4. The method of claim 3, wherein the voice input pattern is one of a plurality of pre-determined voice input patterns.

5. The method of claim 2, wherein the gesture input pattern comprises at least one of flicking, a touch and drag, a tap and hold, and a multi-tab on a touchscreen of the electronic device.

6. The method of claim 2, wherein the gesture input pattern comprises receiving a drawing input pattern on a touchscreen of the electronic device.

7. The method of claim 6, wherein the drawing input pattern comprises a touch for a plurality of objects, and the plurality of objects have a unique data value.

8. The method of claim 7, wherein identifying the pattern ID from the input pattern comprises combining with a unique data value to generate a character string.

9. The method of claim 8, wherein determining a counterpart electronic device corresponding to the pattern ID comprises:
determining whether the counterpart electronic device has an ID matching the pattern ID.

10. The method of claim 1, wherein determining a counterpart electronic device corresponding to the pattern ID comprises:
comparing the received input pattern of the electronic device with a input pattern of the counterpart electronic device.

11. The method of claim 1, further comprising:
when a number of the counterpart electronic devices is more than one, prioritizing the wireless connections with the counterpart electronic devices.

12. An electronic device comprising:
a wireless communication unit configured to perform wireless communication with one or more other electronic devices;
a pattern input unit configured to receive an input pattern; and
a processor configured to identify a pattern from the input pattern, determine a counterpart electronic device with an ID corresponding to the pattern, and cause the wireless communication unit to wirelessly connect with the counterpart electronic device.

13. The electronic device of claim 12, wherein the pattern input unit is a touchscreen configured to receive a gesture input pattern.

14. The electronic device of claim 12, wherein the pattern input unit is an audio unit configured to receive a voice input pattern.

15. The electronic device of claim 13, wherein the gesture input pattern comprises at least one of flicking, a touch and drag, a tab and hold, and a multi tab on the touchscreen.

16. The electronic device of claim 13, wherein the processor is configured to receive a drawing input pattern comprising a touch for a plurality of objects having a unique data value on the touchscreen.

17. The electronic device of claim 16, wherein the processor is configured to combine the unique data value to generate a character string.

18. The electronic device of claim 17, wherein the processor is configured to determine whether the counterpart ID is the same as the character string or comprises partially same text.

19. A method for operating an electronic device, the method comprising:
receiving a gesture input pattern or a voice input pattern, the gesture input pattern comprising at least one of a touch on a touchscreen, a drag of the touch, and a release of the touch, and the voice input pattern comprising at least one predetermined voice pattern;
identifying a pattern identification (ID) from the input pattern, the pattern ID being data comprising at least one of a number and a character;
determining a counterpart electronic device having an ID corresponding to the pattern ID, the counterpart ID comprising data that is at least in part same as the data of the pattern ID; and
performing wireless connection with the counterpart electronic device.

20. A non-transient computer readable storage medium storing one or more programs comprising instructions, when executed by an electronic device, for allowing the electronic device to perform the method comprising:
receiving an input pattern;
identifying a pattern identification (ID) from the input pattern;
determining a counterpart electronic device corresponding to the pattern ID; and
establishing a wireless connection with the corresponding electronic device.
